(19) United States
(12) Patent Application Publication
(10) Pub. No.: US 2012/0116738 A1
(43) Pub. Date: May 10, 2012

(54) Systems And Methods For Modeling Drillstring Trajectories

(75) Inventor: Robert Franklin Mitchell, Houston, TX (US)

(73) Assignee: Landmark Graphics Corporation, Houston, TX (US)

(21) Appl. No.: 13/383,374

(22) PCT Filed: Jul. 10, 2009
(86) PCT No.: PCT/US09/50211

§ 371 Date: Jan. 10, 2012

(51) Int. Cl. G06F 17/16

(52) U.S. Cl. 703/2

(57) ABSTRACT

Systems and methods for modeling drillstring trajectories by calculating forces in the drillstring using a traditional torque-drag model and comparing the results with the results of the same forces calculated in the drillstring using a block tri-diagonal matrix, which determines whether the new drillstring trajectory is acceptable and represents mechanical equilibrium of drillstring forces and moments.

### CROSS-REFERENCE TO RELATED APPLICATIONS

The priority of PCT Patent Application No. PCT/US09/50211, filed on Jul. 10, 2009, is hereby claimed, and the specification thereof is incorporated herein by reference.

### STATEMENT REGARDING FEDERALLY SPONSORED RESEARCH

Not applicable.

### FIELD OF THE INVENTION

The present invention generally relates to modeling drillstring trajectories. More particularly, the present invention relates to calculating forces in the drillstring using a traditional torque-drag model and comparing the results with the results of the same forces calculated in the drillstring using a block tri-diagonal matrix, which determines whether the new drillstring trajectory is acceptable and represents mechanical equilibrium of drillstring forces and moments.

### BACKGROUND OF THE INVENTION

Analysis of drillstring loads is typically done with drillstring computer models. By far the most common method for drillstring analysis is the “torque-drag” model originally described in the Society of Petroleum Engineers article “Torque and Drag in Directional Wells—Prediction and Measurement” by Johancsik, C. A., Dawson, R. and Friesen, D. B., which was later translated into differential equation form as described in the article “Designing Well Paths to Reduce Drag and Torque” by Sheppard, M. C., Wick, C. and Burgess, T. M. This model is known to be an approximation of real drillstring behavior; in particular, that the bending stiffness is neglected. The torque-drag model is therefore, often called a “soft-string” model. There have been many “stiff-string” models developed, but there is no “industry standard” formulation.

Torque-drag modeling refers to the torque and drag related to drillstring operation. Drag is the excess load compared to rotating drillstring weight, which may be either positive when pulling the drillstring or negative while sliding into the well. This drag force is attributed to friction generated by drillstring contact with the wellbore. When rotating, this same friction will reduce the surface torque transmitted to the drill bit. Being able to estimate the friction forces is useful when planning a well or analysis afterwards. Because of the simplicity and general availability of the torque-drag model, it has been used extensively for planning and in the field. Field experience indicates that this model generally gives good results for many wells, but sometimes performs poorly.

In the standard torque-drag model, the drillstring trajectory is assumed to be the same as the wellbore trajectory, which is a reasonable assumption considering that surveys are taken within the drillstring. Contact with the wellbore is assumed to be continuous. Given that the most common method for determining the wellbore trajectory is the minimum curvature method, this model is less than ideal because the bending moment is not continuous and smooth at survey points. This problem is dealt with by neglecting bending moment but, as a result of this assumption, some of the contact force is also neglected. In other words, some contact forces and axial loads are missing from the model.

There is therefore, a need for a new drillstring trajectory model that does not neglect the bending moment, contact forces and axial loads along the drillstring.

### SUMMARY OF THE INVENTION

The present invention meets the above needs and overcomes one or more deficiencies in the prior art by providing systems and methods for modeling a drillstring trajectory, which maintains bending moment continuity and enables more accurate calculations of torque and drag forces.

In one embodiment, the present invention includes a method for modeling a drillstring trajectory, comprising i) calculating an initial value of force and an initial value of moment for each joint along a drillstring model using a conventional torque-drag model, a tangent vector, a normal vector and a bi-normal vector for each respective joint; ii) calculating a block tri-diagonal matrix for each connector on each joint; and iii) modeling a drillstring trajectory by solving the block tri-diagonal matrix for two unknown rotations at each connector.

In another embodiment, the present invention includes a program carrier device for carrying computer executable instructions for modeling a drillstring trajectory. The instructions are executable to implement i) calculating an initial value of force and an initial value of moment for each joint along a drillstring model using a conventional torque-drag model, a tangent vector, a normal vector and a bi-normal vector for each respective joint; ii) calculating a block tri-diagonal matrix for each connector on each joint; and iii) modeling a drillstring trajectory by solving the block tri-diagonal matrix for two unknown rotations at each connector.

Additional aspects, advantages and embodiments of the invention will become apparent to those skilled in the art from the following description of the various embodiments and related drawings.

### BRIEF DESCRIPTION OF THE DRAWINGS

The present invention is described below with references to the accompanying drawings in which like elements are referenced with like reference numerals, and in which:

FIG. 1 is a block diagram illustrating one embodiment of a system for implementing the present invention.

FIG. 2A is a side view of a tool joint connection, which illustrates the loads and moments generated by sliding without rotating.

FIG. 2B is an end view of the tool joint connection illustrated in FIG. 2A.

FIG. 3A is a side view of a tool joint connection, which illustrates the loads and moments generated by rotating without sliding.

FIG. 3B is an end view of the tool joint connection illustrated in FIG. 3A.

FIG. 4 is a flow diagram illustrating one embodiment of a method for implementing the present invention.

### DETAILED DESCRIPTION OF THE PREFERRED EMBODIMENTS

The subject matter of the present invention is described with specificity, however, the description itself is not intended to limit the scope of the invention. The subject matter thus, might also be embodied in other ways, to include different steps or combinations of steps similar to the ones described herein, in conjunction with other present or future technologies. Moreover, although the term “step” may be used herein to describe different elements of methods employed, the term should not be interpreted as implying any particular order among or between various steps herein disclosed unless otherwise expressly limited by the description to a particular order. While the following description refers to the oil and gas industry, the systems and methods of the present invention are not limited thereto and may also be applied to other industries to achieve similar results.

### System Description

The present invention may be implemented through a computer-executable program of instructions, such as program modules, generally referred to as software applications or application programs executed by a computer. The software may include, for example, routines, programs, objects, components, and data structures that perform particular tasks or implement particular abstract data types. The software forms an interface to allow a computer to react according to a source of input. WELLPLAN™, which is a commercial software application marketed by Landmark Graphics Corporation, may be used as an interface application to implement the present invention. The software may also cooperate with other code segments to initiate a variety of tasks in response to data received in conjunction with the source of the received data. The software may be stored and/or carried on any variety of memory media such as CD-ROM, magnetic disk, bubble memory and semiconductor memory (e.g., various types of RAM or ROM). Furthermore, the software and its results may be transmitted over a variety of carrier media such as optical fiber, metallic wire, free space and/or through any of a variety of networks such as the Internet.

Moreover, those skilled in the art will appreciate that the invention may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present invention. The invention may be practiced in distributed-computing environments where tasks are performed by remote-processing devices that are linked through a communications network. In a distributed-computing environment, program modules may be located in both local and remote computer-storage media including memory storage devices. The present invention may therefore, be implemented in connection with various hardware, software or a combination thereof, in a computer system or other processing system.

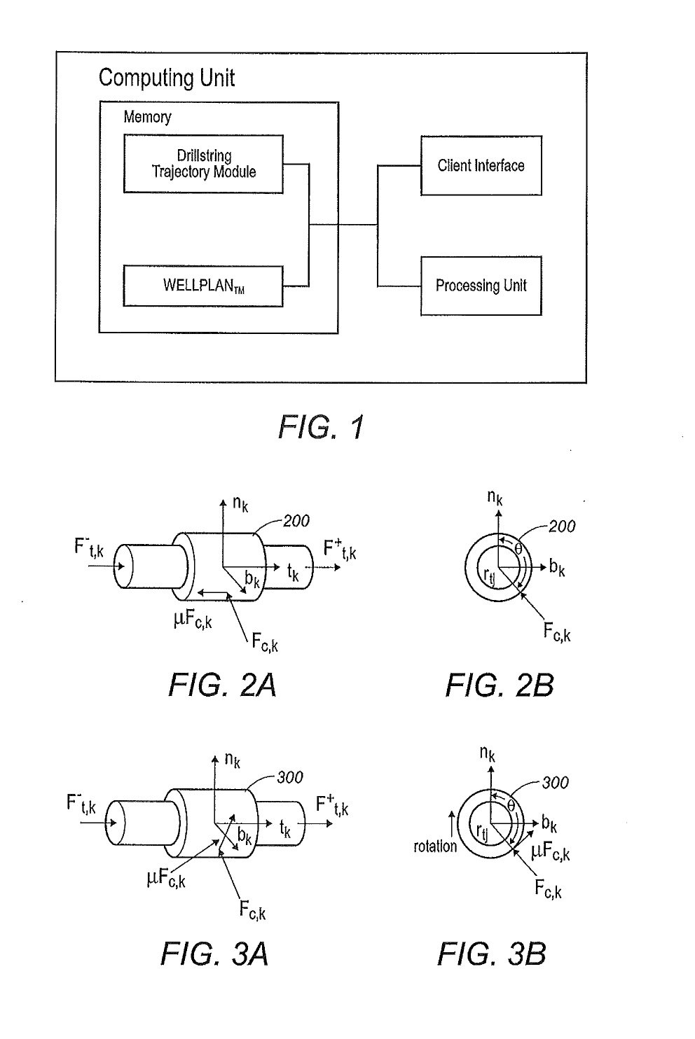

Referring now to FIG. 1, a block diagram of a system for implementing the present invention on a computer is illustrated. The system includes a computing unit, sometimes referred to as a computing system, which contains memory, application programs, a client interface, and a processing unit. The computing unit is only one example of a suitable computing environment and is not intended to suggest any limitation as to the scope of use or functionality of the invention.

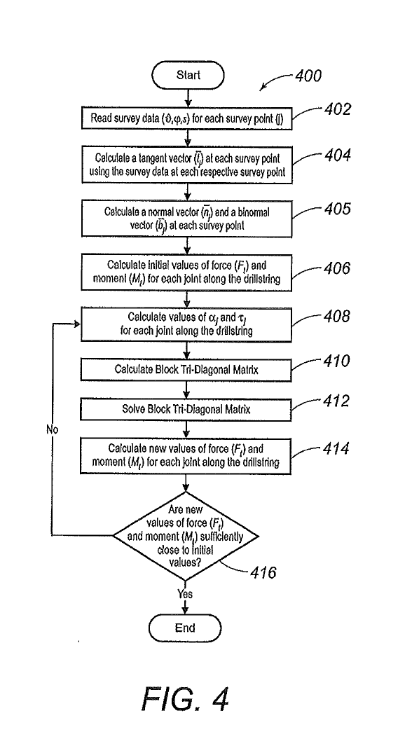

The memory primarily stores the application programs, which may also be described as program modules containing computer-executable instructions, executed by the computing unit for implementing the methods described herein and illustrated in FIG. 4. The memory therefore, includes a Drillstring Trajectory Module and a WELLPLAN™ module, which enable the methods illustrated and described in reference to FIG. 4. The WELLPLAN™ module may supply the Drillstring Trajectory Module with the minimum curvature trajectory and initial values of force and moment needed to model the drillstring trajectory. The Drillstring Trajectory Module may supply the WELLPLAN™ module with the improved drillstring trajectory model, along with improved values of forces and moments that may be used to further analyze and evaluate the drillstring design.

Although the computing unit is shown as having a generalized memory, the computing unit typically includes a variety of computer readable media. By way of example, and not limitation, computer readable media may comprise computer storage media and communication media. The computing system memory may include computer storage media in the form of volatile and/or nonvolatile memory such as a read only memory (ROM) and random access memory (RAM). A basic input/output system (BIOS), containing the basic routines that help to transfer information between elements within the computing unit, such as during start-up, is typically stored in ROM. The RAM typically contains data and/or program modules that are immediately accessible to, and/or presently being operated on by, the processing unit. By way of example, and not limitation, the computing unit includes an operating system, application programs, other program modules, and program data.

The components shown in the memory may also be included in other removable/nonremovable, volatile/nonvolatile computer storage media. For example only, a hard disk drive may read from or write to nonremovable, nonvolatile magnetic media, a magnetic disk drive may read from or write to a removable, non-volatile magnetic disk, and an optical disk drive may read from or write to a removable, nonvolatile optical disk such as a CD ROM or other optical media. Other removable/non-removable, volatile/non-volatile computer storage media that can be used in the exemplary operating environment may include, but are not limited to, magnetic tape cassettes, flash memory cards, digital versatile disks, digital video tape, solid state RAM, solid state ROM, and the like. The drives and their associated computer storage media discussed above therefore, store and/or carry computer readable instructions, data structures, program modules and other data for the computing unit.

A client may enter commands and information into the computing unit through the client interface, which may be input devices such as a keyboard and pointing device, commonly referred to as a mouse, trackball or touch pad. Input devices may include a microphone, joystick, satellite dish, scanner, or the like.

These and other input devices are often connected to the processing unit through the client interface that is coupled to a system bus, but may be connected by other interface and bus structures, such as a parallel port or a universal serial bus (USB). A monitor or other type of display device may be connected to the system bus via an interface, such as a video interface. In addition to the monitor, computers may also include other peripheral output devices such as speakers and printer, which may be connected through an output peripheral interface.

Although many other internal components of the computing unit are not shown, those of ordinary skill in the art will appreciate that such components and their interconnection are well known.

### Method Description

The following drillstring trajectory model is distinctive by being fully three dimensional in formulation, even though the wellbore trajectory is defined by the minimum curvature method. The minimum curvature wellbore trajectory model used in most torque-drag models is two dimensional. The new drillstring trajectory model provides point of contact at the connectors (“tool joints”), which join the sections (“joints”) of drillpipe into a drillstring. This is more accurate than the full wellbore pipe contact assumption used by conventional torque-drag models. By proper choice of the connector rotation, bending moment continuity can be maintained because only the connectors correspond with the drillstring trajectory—leaving the joints of drillpipe free to move about in order to achieve mechanical equilibrium. Conventional drillstring trajectory models, like the torque-drag model, cannot satisfy this objective. The present invention therefore, provides more accurate values of forces and moments used in modeling the drillstring trajectory. The nomenclature used herein is described in Table 1 below.

TABLE 1
Minimum Curvature Wellbore Trajectory

| | |
|---|---|
| Aₚ | cross-sectional area of the pipe (in²) |
| \vec{b} | binormal vector |
| b_{z} | z coordinate of the binormal vector |
| I | moment of inertia (ft⁴) |
| E | Young's elastic modulus (psf) |
| Fₐ | actual axial force in the pipe (Ibf) |
| Fₑ | the effective force (Ibf) |
| Fₛₜ | pressure-area force terms, the “stream |
| | thrust” (lbf) |
| Mₜ | Axial torque (lbf/in) |
| \vec{n} | Normal vector |
| n_{z} | z coordinate of the normal vector |
| \vec{r} | position vector (in) |
| R | radius of curvature (in) |
| r_{c} | radial clearance (in) |
| rᵢ | pipe inside radius (in) |
| rₚ | pipe outside radius (in) |
| s | measured depth (ft) |
| \vec{t} | tangent vector |
| t_{z} | z coordinate of the tangent vector |
| wₐ | axial distributed load (lbf/in) |
| w_{bp} | buoyant weight of the pipe (lbf/in) |
| wₛₜ | gradient of the stream thrust (lbf/in) |
| Δw_{ef} | excess annular fluid loads (lbf/in) |
| κⱼ | wellbore curvature (in⁻¹) |
| μ_{f} | dynamic friction coefficient |
| Ψ | angle between survey tangent vectors |
| j | survey point |
| k | joint |

The normal method for determining the well path f(s) is to use some type of surveying instrument to measure the inclination and azimuth at various depths and then to calculate the trajectory. At each survey point j, inclination angle φⱼ and azimuth angle θⱼ are measured, as well as the course length Δsⱼ=sⱼ₊₁−sⱼ between survey points. Each survey point j therefore, includes survey data comprising an inclination angle φⱼ, an azimuth angle θⱼ and a measured depth sⱼ, which increases with depth. These angles have been corrected (i) to true north for a magnetic survey or (ii) for drift if a gyroscopic survey. The survey angles define the tangent \vec{t}ⱼ to the trajectory at each survey point j where the tangent vector \vec{t}_{J} is defined in terms of inclination φⱼ and azimuth θⱼ in the following equations:

\vec{t}ⱼ·\vec{i}_{N}=cos(θⱼ)sin(φⱼ)

\vec{t}ⱼ·\vec{i}_{E}=sin(θⱼ)sin(φⱼ)

\vec{t}ⱼ·\vec{i}_{z}=cos(φⱼ) (A-0)

A constant tangent vector \vec{t}ⱼ between measured depths sⱼ and sⱼ₊₁, integrates into a straight line wellbore trajectory:

\vec{r}ⱼ(s)=\vec{r}ⱼ+\vec{t}ⱼ(s−sⱼ) (A-1)

The method most commonly used to define a well trajectory is called the minimum curvature method. In this method, two tangent vectors are connected with a circular arc. If there is a circular arc of radius Rⱼ over angle ψⱼ, connecting the two tangent vectors \vec{t}ⱼ at measured depth sⱼ, and \vec{t}ⱼ₊₁ at measured depth sⱼ₊₁, then the arc length is Rⱼψⱼ=sⱼ₊₁−sⱼ=Δsⱼ. From this Rⱼ may be determined by:

Rⱼ=Δsⱼ/ψⱼ=Δsⱼ/cos⁻¹(\vec{t}ⱼ₊₁·\vec{t}ⱼ)=1/κⱼ (A-2)

The following equations define a circular arc:

\vec{r}ⱼ(s)=\vec{t}ⱼRⱼ sin [κⱼ(s−sⱼ)]+\vec{n}ⱼRⱼ{1−cos [κⱼ(s−sⱼ)]}+\vec{r}ⱼ (A-3(a))

\vec{t}ⱼ(s)=\vec{t}ⱼ cos [κⱼ(s−sⱼ)]+\vec{n}ⱼ sin [κⱼ(s−sⱼ)] (A-3(b))

\vec{n}ⱼ(s)=−\vec{t}ⱼ sin [κⱼ(s−sⱼ)]+\vec{n}ⱼ cos [κⱼ(s−sⱼ)] (A-3(c))

\vec{b}ⱼ(s)=\vec{t}ⱼ×\vec{n}ⱼ=\vec{b}ⱼ (A-3(d))

The vector \vec{r}ⱼ is just the initial position at s=sⱼ. The vector \vec{t}ⱼ is the initial tangent vector. The vector \vec{n}ⱼ is the initial normal vector. If equation (A-3(b)) is evaluated at s=sⱼ₊₁, then:

\vec{t}(sⱼ₊₁)=\vec{t}ⱼ cos κⱼΔsⱼ+\vec{n}ⱼ sin κⱼΔsⱼ=\vec{t}ⱼ₊₁ (A-4)

which can be solved for \vec{n}ⱼ by:

$${\vec{n}}_{j} = \frac{{\vec{t}}_{j + 1} - {\vec{t}}_{j} cos ( {κ}_{j} Δ {s}_{j} )}{sin ( {κ}_{j} Δ {s}_{j} )} = {\vec{t}}_{j + 1} csc ( {κ}_{j} Δ {s}_{j} ) - {\vec{t}}_{j} cot ( {κ}_{j} Δ {s}_{j} ) \qquad ( A \text{-} 5 )$$

Equation (A-5) fails if \vec{t}ⱼ=\vec{t}ⱼ₊₁. For this case, equation (A-1) is used for a straight wellbore. The vector \vec{n}ⱼ can be any vector perpendicular to \vec{t}ⱼ, but is conveniently chosen from an adjacent circular arc, if there is one.

### Drillstring Static Equilibrium Equations

The change in the drillstring force \vec{F} due to applied load vector \vec{w} is given by the following equation:

$$\frac{d \vec{F}}{d s} + \vec{w} = \vec{0} \qquad ( B \text{-} 1 )$$

where \vec{w} is force per length of the drillstring. The change in moment \vec{M} due to applied moment vector \vec{m} and pipe force \vec{F} is given by the following equation:

$$\frac{d \vec{M}}{d s} + \vec{t} \times \vec{F} + \vec{m} = \vec{0} \qquad ( B \text{-} 2 )$$

The total drillstring load vector \vec{w} is:

\vec{w}=\vec{w}_{bp}+\vec{w}ₛₜ+Δ\vec{w}_{ef} (B-3)

The buoyant weight \vec{w}_{bp} of the pipe may be defined as:

\vec{w}_{bp}=[wₚ+(ρᵢAᵢ−ρₒAₒ)g]\vec{i}_{z} (B-4)

The next term (\vec{w}ₛₜ) is the gradient of the pressure-area forces. The pressure-area forces, when fluid momentum is added, are known as the stream thrust terms (Fₛₜ) which are given by:

$${\begin{matrix}{\vec{F}}_{st} = [ ( {p}_{o} + {ρ}_{o} {v}_{o}^{2} ) {A}_{o} - ( {p}_{i} + {ρ}_{i} {v}_{i}^{2} ) {A}_{i} ] \vec{t} \\ {\vec{w}}_{st} = \frac{d {\vec{F}}_{st}}{d s} & □ & ( B \text{-} 5 )\end{matrix}}_{st} \qquad ( B \text{-} 5 )$$

The term Δ\vec{w}_{ef} is due to complex flow patterns in the annulus. For many cases of interest, this term is zero, particularly for static fluid and for narrow annuli without pipe rotation. Because of the advanced nature of the computation of this term, this term will be neglected for the remaining discussion.

The drillstring is modeled as an elastic solid material. Since a solid material can develop shear stresses, \vec{F} may be formulated in the following way:

\vec{F}=Fₐ\vec{t}+Fₙ\vec{n}+F_{b}\vec{b} (B-6)

where Fₐ is the axial force, Fₙ is the shear force in the normal direction, and F_{b} is the shear force in the binormal direction. If equation (B-6) is considered with the equilibrium equation (B-1), the stream thrust terms may be grouped with the axial force to define the effective tension Fₑ:

$${F}_{e} = {F}_{a} + {F}_{st} = {F}_{a} + ( {p}_{o} + {ρ}_{o} {v}_{o}^{2} ) {A}_{o} - ( {p}_{i} + {ρ}_{i} {v}_{i}^{2} ) {A}_{i} \qquad ( B \text{-} 7 )$$

Equation (B-1) now becomes:

$$\frac{d {\vec{F}}_{e}}{d s} + {\vec{w}}_{bp} = \vec{0} \qquad ( B \text{-} 8 )$$

where \vec{F}ₑ is called the effective force, which may be represented by:

\vec{F}ₑ=Fₑ\vec{t}+Fₙ\vec{n}+F_{b}\vec{b} (B-9)

The casing moments for a circular pipe are given by:

\vec{M}=EIκ\vec{b}+Mₜ\vec{t} (B-10)

where EI is the bending stiffness and Mₜ is the axial torque.

### Drillstring Displacements

The conventional torque-drag drillstring model uses a large displacement formulation because it may consider, for instance, a build section with a radius as small as 300 feet and a final inclination as high as 90°. In this model, thirty (30) foot sections (joints) of drillpipe are considered because this is the most common length used in a drillstring. Over this length, the build section just described traverses an arc of only about 6°. The analysis may be simplified by defining a local Cartesian coordinate system for each joint of drillpipe. Over the measured depth interval (sₖ,sₖ₊₁), which is a sub-interval of the trajectory interval (sⱼ, sⱼ₊₁), the drillpipe displacement may be defined by:

\vec{u}ₖ(s)=\vec{r}ⱼ(s)+U_{n,k}(s)\vec{n}ₖU_{b,k}(s)\vec{b}ₖ (1)

The local Cartesian coordinate system is:

$$( \begin{matrix}{\vec{t}}_{k} \\ {\vec{n}}_{k} \\ {\vec{b}}_{k}\end{matrix} ) = ( \begin{matrix}{\vec{t}}_{j} ( {s}_{k} ) \\ {\vec{n}}_{j} ( {s}_{k} ) \\ {\vec{b}}_{j} ( {s}_{k} )\end{matrix} ) \qquad ( 2 )$$

The following boundary conditions are required:

U_{n,k}(sₖ)=0

U_{n,k}(sₖ₊₁)=0

U_{b,k}(sₖ)=0

U_{b,k}(sₖ₊₁)=0 (3)

And, the following conditions are required at the connectors:

$$\frac{d {U}_{n , k} ( {s}_{k + 1} )}{d s} = [ \frac{d {U}_{n , k + 1} ( {s}_{k + 1} )}{d s} {\vec{n}}_{k + 1} + \frac{d {U}_{b , k + 1} ( {s}_{k + 1} )}{d s} {\vec{b}}_{k + 1} ] \cdot {\vec{n}}_{k} \\ \frac{d {U}_{b , k} ( {s}_{k + 1} )}{d s} = [ \frac{d {U}_{n , k + 1} ( {s}_{k + 1} )}{d s} {\vec{n}}_{k + 1} + \frac{d {U}_{b , k + 1} ( {s}_{k + 1} )}{d s} {\vec{b}}_{k + 1} ] \cdot {\vec{b}}_{k} \qquad ( 4 )$$

The boundary conditions (3) force the drillstring displacement to equal the wellbore displacement at the connectors between the joints of drillpipe. In the conventional torque-drag model, the drillpipe displacement equals the wellbore displacement at every point. This model restricts drillpipe displacements only at a finite number of distinct points, defined by the length of the drillpipe joints. In a general drillstring analysis, displacements of the drillpipe would only be restricted to lie within the wellbore radius and points of contact would be unknown, to be determined by the analysis. The conditions at the connectors (4) define continuity of slope across each connector (tool joint). The connector is allowed to rotate relative to the wellbore centerline. This rotation is initially unknown but may be determined by the displacement calculations, equations (16) or (18), depending on the criterion established in equations (13). To make the rotations explicit, either equations (16) or equations (18) must be solved for boundary conditions (3), connector conditions (4) and the remaining unknown coefficients used to determine functions f_{1,k}, g_{1,k}, f_{2,k}, g_{2,k} in equations (20). The unknown rotations for a joint k, x_{1,k}, x_{2,k}, x_{1,k+1}, and x_{2,k+1}, are determined by solving equations (21).

### Drillstring Static Equilibrium

Because fluid densities and pipe weight are constant over each joint k, the force equilibrium equation (B-8) may be solved by:

\vec{F}_{e,k}(s)=\vec{F}⁺_{e,k}−\vec{w}_{bp}(s−sₖ) (5)

The plus sign indicates that the force is evaluated for s greater than sₖ. The force for s less than sₖ will be different because the forces are discontinuous at each connector. The discontinuity in the force is caused by the contact force and friction force at the connector due to contact with the wellbore wall. For sliding friction:

\vec{Fe}_{e,k}⁺−F_{e,k}⁻=N_{n,k}\vec{n}ₖ+N_{b,k}\vec{b}ₖ±μₛ\sqrt{N_{n,k}²+N_{b,k}²}\vec{t}ₖ (6)

where the friction force direction opposes the direction of sliding, positive for upward motion, negative for downward motion. For rotation:

\vec{F}_{e,k}⁺−\vec{F}_{e,k}⁻=(N_{n,k}−μₛN_{b,k})\vec{n}ₖ+(N_{b,k}+μₛN_{n,k})\vec{b}ₖ (7)

where the friction force direction assumes a clockwise rotation direction. The value of F_{e,k}⁻ is given by:

\vec{F}_{e,k}⁻=\vec{F}_{e,k-1}(sₖ) (8)

Starting with an initial force value, typically a value of weight on the drill bit, the remaining forces at the connectors can be evaluated, given the contact forces.

Satisfying the balance of moment equation (B-2) is more complex, however. Through use of equation (B-10), equation (B-2) can be reduced to:

$${\vec{F}}_{e} = - EI \frac{{d}^{3} {\vec{u}}_{k}}{d {s}^{3}} + ( {\vec{F}}_{e} \cdot {\vec{t}}_{k} ( s ) - EI {κ}^{2} ) \frac{d {\vec{u}}_{k}}{d s} + {M}_{t} \frac{d {\vec{u}}_{k}}{d s} \times \frac{{d}^{2} {\vec{u}}_{k}}{d {s}^{2}} \qquad ( 9 )$$

where Mₜ is constant between connectors.

The derivatives can be evaluated from equation (1) by:

$$\frac{d {\vec{u}}_{k}}{d s} = cos [ {κ}_{k} ( s - {s}_{k} ) ] {\vec{t}}_{k} + \{ sin [ {κ}_{k} ( s - {s}_{k} ) ] + \frac{d {U}_{n} ( s )}{d s} \} {\vec{n}}_{k} + \frac{d {U}_{b} ( s )}{d s} {\vec{b}}_{k} \\ \frac{{d}^{2} {\vec{u}}_{k}}{d {s}^{2}} = - {κ}_{k} sin [ {κ}_{k} ( s - {s}_{k} ) ] {\vec{t}}_{k} + \{ {κ}_{k} cos [ {κ}_{k} ( s - {s}_{k} ) ] + \frac{{d}^{2} {U}_{n} ( s )}{d {s}^{2}} \} {\vec{n}}_{k} + \frac{{d}^{2} {U}_{b} ( s )}{d {s}^{2}} {\vec{b}}_{k} \\ \frac{{d}^{3} {\vec{u}}_{k}}{d {s}^{3}} = - {κ}_{k}^{2} cos [ {κ}_{k} ( s - {s}_{k} ) ] \vec{t} + \{ - {κ}_{k}^{2} sin [ {κ}_{k} ( s - {s}_{k} ) ] + \frac{{d}^{3} {U}_{n} ( s )}{d {s}^{3}} \} {\vec{n}}_{k} + \frac{{d}^{3} {U}_{b} ( s )}{d {s}^{3}} {\vec{b}}_{k} \qquad ( 10 )$$

When the derivatives described in equation (10) are substituted into equation (9), and terms of order κₖ² and higher are eliminated, the balance of moment gives:

$$\begin{matrix}EI \frac{{d}^{3} {U}_{n}}{d {s}^{3}} + {M}_{t} \frac{{d}^{2} {U}_{b}}{d {s}^{2}} - {F}_{t} \frac{d {U}_{n}}{d s} + {F}_{n , k}^{+} - {κ}_{k} {F}_{t , k}^{+} ( s - {s}_{k} ) {w}_{bp} ( s - {s}_{k} ) [ {κ}_{k} {t}_{kz} ( s - {s}_{k} ) - {n}_{kz} ] = 0 & ( 11 \text{-} a ) \\ EI \frac{{d}^{3} {U}_{b}}{d {s}^{3}} - {M}_{t} \frac{{d}^{2} {U}_{n}}{d s} - {F}_{t} \frac{d {U}_{b}}{d s} + {F}_{b , k}^{+} - {M}_{t} {κ}_{k} - {w}_{bp} {b}_{kz} ( s - {s}_{k} ) = 0 & ( 11 \text{-} b ) \\ {F}_{t} = {F}_{t , k}^{+} - {w}_{bp} {t}_{kz} ( s - {s}_{k} ) & ( 11 \text{-} c )\end{matrix}$$

At this stage F_{n,k}⁺ and F_{b,k}⁺ are unknown constants that may be chosen to satisfy boundary conditions. There are two distinct versions of equations (11-a) and (11-b), depending on the value of

$$\frac{F}{EI} - {( \frac{{M}_{t}}{EI} )}^{2} .$$

If the value of this expression is positive, then:

$$\begin{matrix}\frac{{d}^{3} {U}_{n}}{d {ξ}^{3}} + 2 τ \frac{{d}^{2} {U}_{b}}{d {ξ}^{2}} - ( {α}^{2} + {τ}^{2} ) \frac{d {U}_{n}}{d ξ} + {ω}_{01} + {ω}_{11} ξ + {ω}_{21} {ξ}^{2} = 0 & ( 12 \text{-} a ) \\ \frac{{d}^{3} {U}_{b}}{d {ξ}^{3}} - 2 τ \frac{{d}^{2} {U}_{n}}{d {ξ}^{2}} - ( {α}^{2} + {τ}^{2} ) \frac{d {U}_{b}}{d ξ} + \frac{{F}_{b , k}^{+}}{EI} + {ω}_{02} + {ω}_{12} ξ = 0 \\ where \text{:} & ( 12 \text{-} b ) \\ {α}^{2} = \frac{{F}_{t}}{EI} - {( \frac{{M}_{t}}{2 EI} )}^{2} & ( 12 \text{-} c ) \\ τ = \frac{{M}_{t}}{2 EI} & ( 12 \text{-} d ) \\ ξ = s - {s}_{k} & ( 12 \text{-} e )\end{matrix}$$

If the value of this expression is negative, then:

$$\begin{matrix}\frac{{d}^{3} {U}_{n}}{d {ξ}^{3}} + 2 τ \frac{{d}^{2} {U}_{b}}{d {ξ}^{2}} + ( {α}^{2} + {τ}^{2} ) \frac{d {U}_{n}}{d ξ} + {ω}_{01} + {ω}_{11} ξ + {ω}_{21} {ξ}^{2} = 0 & ( 13 \text{-} a ) \\ \frac{{d}^{3} {U}_{b}}{d {ξ}^{3}} - 2 τ \frac{{d}^{2} {U}_{n}}{d {ξ}^{2}} + ( {α}^{2} + {τ}^{2} ) \frac{d {U}_{b}}{d ξ} + {ω}_{02} + {ω}_{12} ξ = 0 \\ where \text{:} & ( 13 \text{-} b ) \\ {α}^{2} = {( \frac{{M}_{t}}{2 EI} )}^{2} - \frac{{F}_{t}}{EI} & ( 13 \text{-} c ) \\ τ = \frac{{M}_{t}}{2 EI} & ( 13 \text{-} d ) \\ ξ = s - {s}_{k} & ( 13 \text{-} e )\end{matrix}$$

And for equations (11), (12-a), (12-b), (13-a) and (13-b):

$${t}_{kz} = {\vec{t}}_{k} \cdot {\vec{e}}_{z} \\ {n}_{kz} = {{n}^{->}}_{k} \cdot {\vec{e}}_{z} \\ {b}_{kz} = {\vec{b}}_{k} \cdot {\vec{e}}_{z} \\ {ω}_{01} = \frac{{F}_{n , k}^{+}}{EI} \\ {ω}_{11} = - \frac{{F}_{t , k}^{+} {κ}_{k} + {w}_{bp} {n}_{kz}}{EI} \\ {ω}_{21} = \frac{{w}_{bp} {t}_{kz} {κ}_{k}}{EI} \\ {ω}_{02} = \frac{{F}_{b , k}^{+} - {M}_{t} {κ}_{k}}{EI} \\ {ω}_{12} = - \frac{{w}_{bp} {b}_{zk}}{EI} \qquad ( 14 )$$

Here Fₜ is treated as if it were constant, which is valid except near the “neutral” point. Equations (12) describe a pipe in “tension”, as clearly Fₜ must be positive. Torque therefore, destabilizes the beam-column system. Equations (13) represent the system that can buckle, because the drillpipe is effectively in “compression.” The “neutral” point of a drillstring is given by:

$$\frac{{F}_{t}}{EI} - {( \frac{{M}_{t}}{2 EI} )}^{2} = 0 \qquad ( 15 )$$

The solution to equations (12) is given by:

$$\begin{matrix}{u}_{1} ( s ) = {c}_{1} + [ {c}_{2} cos ( τ ξ ) + {c}_{3} sin ( τ ξ ) ] cosh ( α ξ ) + \\ [ {c}_{4} cos ( τ ξ ) + {c}_{5} sin ( τ ξ ) ] sinh ( α ξ ) + {a}_{11} s + {a}_{21} {ξ}^{2} + {a}_{31} {ξ}^{3} \\ {u}_{2} ( s ) = {c}_{6} - [ {c}_{3} cos ( τ ξ ) - {c}_{2} sin ( τ ξ ) ] cosh ( α ξ ) - \\ [ {c}_{5} cos ( τ ξ ) - {c}_{4} sin ( τ ξ ) ] sinh ( α ξ ) + {a}_{12} ξ + {a}_{22} {ξ}^{2}\end{matrix} \qquad ( 16 )$$

where cᵢ, i=1 . . . 6 are constants to be determined by boundary conditions, and

$${a}_{11} = \frac{{ω}_{01}}{{α}^{2} + {τ}^{2}} + \frac{2 τ {ω}_{12}}{{( {α}^{2} + {τ}^{2} )}^{2}} - \frac{2 ( 3 {τ}^{2} - {α}^{2} ) {ω}_{21}}{{( {α}^{2} + {τ}^{2} )}^{3}} \\ {a}_{21} = \frac{{ω}_{11}}{2 ( {α}^{2} + {τ}^{2} )} \\ {a}_{31} = \frac{{ω}_{21}}{3 ( {α}^{2} + {τ}^{2} )} \\ {a}_{12} = \frac{{ω}_{02}}{{α}^{2} + {τ}^{2}} - \frac{2 τ {ω}_{11}}{{( {α}^{2} + {τ}^{2} )}^{2}} \\ {a}_{22} = \frac{{ω}_{12}}{2 ( {α}^{2} + {τ}^{2} )} - \frac{2 τ {ω}_{21}}{{( {α}^{2} + {τ}^{2} )}^{2}} \qquad ( 17 )$$

The solution to equations (13) is given by:

$$\begin{matrix}{u}_{1} ( s ) = {c}_{1} + {c}_{2} sin ( {α}_{1} ξ ) + {c}_{3} cos ( {α}_{1} ξ ) + {c}_{4} sin ( {α}_{2} ξ ) + \\ {c}_{5} cos ( {α}_{2} ξ ) + {a}_{11} ξ + {a}_{21} {ξ}^{2} + {a}_{31} {ξ}^{3} \\ {u}_{1} ( s ) = {c}_{6} + {c}_{3} sin ( {α}_{1} ξ ) - {c}_{2} cos ( {α}_{1} ξ ) + {c}_{5} sin ( {α}_{2} ξ ) - \\ {c}_{4} cos ( {α}_{2} ξ ) + {a}_{12} ξ + {a}_{22} {ξ}^{2}\end{matrix} \\ {α}_{1} = τ - α \\ {α}_{2} = τ + α \qquad ( 18 )$$

where cᵢ, i=1 . . . 6 are constants to be determined by boundary conditions, and

$${a}_{11} = \frac{{ω}_{01}}{{τ}^{2} - {α}^{2}} + \frac{2 τ {ω}_{12}}{{( {τ}^{2} - {α}^{2} )}^{2}} - \frac{2 ( 3 {τ}^{2} + {α}^{2} ) {ω}_{21}}{{( {τ}^{2} - {α}^{2} )}^{3}} \\ {a}_{21} = \frac{{ω}_{11}}{2 ( {τ}^{2} - {α}^{2} )} \\ {a}_{31} = \frac{{ω}_{21}}{3 ( {τ}^{2} - {α}^{2} )} \\ {a}_{12} = \frac{{ω}_{02}}{{τ}^{2} - {α}^{2}} - \frac{2 τ {ω}_{11}}{{( {τ}^{2} - {α}^{2} )}^{2}} \\ {a}_{22} = \frac{{ω}_{12}}{2 ( {τ}^{2} - {α}^{2} )} - \frac{2 τ {ω}_{21}}{{( {τ}^{2} - {α}^{2} )}^{2}} \qquad ( 19 )$$

Each solution, either to equations (16) or equations (18), has eight unknown constants, the six constants (C1 to C6) and the two constants F_{n,k}⁺ and F_{b,k}⁺. Four constants are used to satisfy equation (6). The remaining constants define the rotations χ_{i,k} at the connectors.

Having determined the unknown constants in equations (16) or equations (18), the displacements Uₙ and U_{b} can be written in the following form in terms of rotations χₙ and χ_{b}:

$${u}_{1} = {f}_{1 , k} ( {ξ}_{k} ) {χ}_{1 , k} + {g}_{1 , k} ( {ξ}_{k} ) {χ}_{1 , k + 1} \\ {u}_{2} = {f}_{2 , k} ( {ξ}_{k} ) {χ}_{2 , k} + {g}_{2 , k} ( {ξ}_{k} ) {χ}_{2 , k + 1} \\ {f}_{1 , k} ( 0 ) = 0 , {f}_{1 , k} ( {Δ}_{k} ) = 0 , {g}_{1 , k} ( 0 ) = 0 , {g}_{1 , k} ( {Δ}_{k} ) = 0 \\ \frac{d}{d s} {f}_{1 , k} ( 0 ) = 1 , \frac{d}{d s} {f}_{1 , k} ( {Δ}_{k} ) = 0 , \frac{d}{d s} {g}_{1 , k} ( 0 ) = 0 , \\ \frac{d}{d s} {g}_{1 , k} ( {Δ}_{k} ) = 1 \\ {f}_{2 , k} ( 0 ) = 0 , {f}_{2 , k} ( {Δ}_{k} ) = 0 , {g}_{2 , k} ( 0 ) = 0 , {g}_{2 , k} ( {Δ}_{k} ) = 0 \\ \frac{d}{d s} {f}_{2 , k} ( 0 ) = 1 , \frac{d}{d s} {f}_{2 , k} ( {Δ}_{k} ) = 0 , \frac{d}{d s} {g}_{2 , k} ( 0 ) = 0 , \\ \frac{d}{d s} {g}_{2 , k} ( {Δ}_{k} ) = 1 \\ {ξ}_{k} = s - {s}_{k} \\ {Δ}_{k} = {s}_{k + 1} - {s}_{k} \qquad ( 20 )$$

Continuity of displacement, equations (3) removes 4 constants. At this point, four unknown constants remain—the two rotations at each end of the joint. The rotations must be continuous between joints (conditions at connectors (4)), which removes two additional constants. Therefore, at each connector there are two unknown rotations. These rotations may be determined by requiring the bending moment to be continuous at the connectors. This condition removes the major fault of conventional torque-drag modeling, which may have discontinuous moments at survey points. This requirement is expressed by:

$${M}_{k , n}^{+} - {M}_{k , n}^{-} = Δ {M}_{k , n} \\ {M}_{k , b}^{+} - {M}_{k , b}^{-} = Δ {M}_{k , b} \\ {M}_{k , n}^{-} = {EI}_{k} [ \frac{{d}^{2} {U}_{n , k} ( {s}_{k + 1} )}{d {s}^{2}} + {κ}_{k} ] \\ {M}_{k , n}^{+} = {EI}_{k + 1} \{ [ \frac{{d}^{2} {U}_{n , k + 1} ( {s}_{k + 1} )}{d {s}^{2}} + {κ}_{k + 1} ] {\vec{n}}_{k + 1} + \frac{{d}^{2} {U}_{b , k + 1} ( {s}_{k + 1} )}{d {s}^{2}} {\vec{b}}_{k + 1} \} \cdot {\vec{n}}_{k} \\ {M}_{k , n}^{+} = {EI}_{k} [ \frac{{d}^{2} {U}_{b , k} ( {s}_{k + 1} )}{d {s}^{2}} ] \\ {M}_{k , n}^{+} = {EI}_{k + 1} \{ [ \frac{{d}^{2} {U}_{n , k + 1} ( {s}_{k + 1} )}{d {s}^{2}} + {κ}_{k + 1} ] {\vec{n}}_{k + 1} + \frac{{d}^{2} {U}_{b , k + 1} ( {s}_{k + 1} )}{d {s}^{2}} {\vec{b}}_{k + 1} \} \cdot {\vec{b}}_{k} \qquad ( 21 )$$

Referring now to FIGS. 2A and 2B, the loads and movement generated by sliding, without rotating, are illustrated in a side view (FIG. 2A) of a tool joint connection 200 and an end view (FIG. 2B) of the tool joint connection 200. The forces and moments are modified due to the sliding of the tool joint connection 200—together with the friction produced by contact forces.

Once the χ_{i,k} have been determined by the solution of equation (21), which is a block tri-diagonal matrix equation, the unknown constants F_{n,k}⁺ and F_{b,k}⁺ (the values at s=sₖ) can be determined from equations (14) and equations (20). The values of F_{n,k}⁻ and F_{b,k}⁻ (the values at s=sₖ₊₁) can be determined from F_{n,k}⁺ and F_{b,k}⁺ and equation (5). The magnitude of the contact force is determined from the change in the shear forces, which is:

$${\vec{F}}_{c , k} = ( {F}_{n , k}^{+} - {F}_{n , k}^{-} ) {\vec{n}}_{k} + ( {F}_{b , k}^{+} - {F}_{b , k}^{-} ) {\vec{b}}_{k} \\ tan θ = \frac{{F}_{n , k}^{+} - {F}_{n , k}^{-}}{{F}_{b , k}^{+} - {F}_{b , k}^{-}} \qquad ( 22 )$$

The friction force is in the negative tangent direction for sliding into the hole, and positive for pulling out. The axial force changes due to the friction force are:

F_{t,k}⁺−F_{t,k}⁻=−μ∥F_{c,k}∥ (23)

where ∥F_{c,k}∥=\sqrt{\vec{F}_{c,k}·\vec{F}_{c,k}}. There is a bending moment induced by the friction force, which is:

ΔM_{k,n}=μrₜⱼ∥F_{c,k}∥sin θ

ΔM_{k,b}=−μrₜⱼ∥F_{c,k}∥cos θ

ΔMk_{k,t}=0 (24)

Referring now to FIGS. 3A and 3B, the loads and moments generated by rotating, without sliding, are illustrated in a side view (FIG. 3A) of a tool joint connection 300 and an end view (FIG. 3B) of the tool joint connection 300. The forces and moments are modified due to the rotating of the tool joint connection 300—together with the friction produced by contact forces.

Once the χ_{i,k} have been determined by the solution of the block tri-diagonal matrix in equation (21), the unknown constants F_{n,k}⁺ and F_{b,k}⁺ (the values at s=sₖ) can be determined from equations (14) and equations (20). The values of F_{n,k}⁻ and F_{b,k}⁻ (the values at s=sₖ₊₁) can be determined from F_{n,k}⁺ and F_{b,k}⁺ and equation (5). The magnitude of the contact force is determined from the change in the shear forces plus the effect of friction, which is:

\vec{F}_{c,k}=(F_{n,k}⁺−F_{n,k}⁻)\vec{n}ₖ+(F_{b,k}⁺−F_{b,k}⁻)\vec{b}ₖ (25)

The change in the shear forces due to the friction force is:

\vec{F}_{c,k}=−F_{c,k}[(cos θ−μ sin θ)\vec{n}+(sin θ+μ cos θ)\vec{b}ₖ]

\vec{F}_{c,k}·\vec{n}ₖ=−F_{c,k}\sqrt{1+μ²}cos(θ+ε)

\vec{F}_{c,k}·\vec{b}ₖ=−F_{c,k}\sqrt{1+μ²}sin(θ+ε)

tan ε=μ (26)

where F_{c,k} is the magnitude of the contact force normal to the tool joint. Calculating the magnitude of \vec{F}_{c,k} which is known in equations (24), enables the magnitude of the normal force to be calculated by:

$${F}_{c , k} = \frac{‖ {{F}^{->}}_{c , k} ‖}{\sqrt{1 + {μ}^{2}}} \qquad ( 27 )$$

The change in the axial force is zero for rotating pipe:

F_{t,k}⁺−F_{t,k}⁻=0 (28)

The change in the torque at the tool joint is given by:

ΔM_{k,n}=0

ΔM_{k,b}=0

M_{k,t}⁺−M_{k,t}⁻=μF_{c,k}rₜⱼ (29)

Referring now to FIG. 4, a diagram illustrates one embodiment of a method 400 for implementing the present invention.

In step 402, survey data (ν, φ, $) is read for each survey point (j) from memory into the WELLPLAN™ module described in reference to FIG. 1. At least two survey points are required to define a wellbore trajectory.

In step 404, a tangent vector (\vec{t}ⱼ) is calculated at each survey point using the survey data (angles) read in step 402 at each respective survey point and equations (A-0). The two angles φ and θare sufficient to define the tangent vector directional components because North (\vec{i}_{N}), East (\vec{i}_{E}) and down (\vec{i}_{Z}) are known. The tangent vector may be calculated in this manner using the WELLPLAN™ module and the processing unit described in reference to FIG. 1.

In step 405, a normal vector (\vec{n}ⱼ) and a bi-normal vector (\vec{b}ⱼ) are calculated at each survey point. The normal vector, for example, may be calculated at each survey point using equation (A-5) and predetermined values for equation (A-2). The bi-normal vector, for example, may be calculated at each survey point using equation (A-3(d)), the respective tangent vector calculated in step 404 and the respective normal vector calculated in step 405. The normal vector and the bi-normal vector may be calculated in this manner using the WELLPLAN™ module and the processing unit described in reference to FIG. 1.

In step 406, initial values of force (Fₜ) and moment (Mₜ) are calculated for each joint along the drillstring using a conventional torque-drag model, such as that described by Shepard in “Designing Wellpaths to Reduce Drag and Torque” in Appendix A and Appendix B, and the respective tangent vector, normal vector and bi-normal vector calculated in steps 404 and 405. The initial values of force and moment for each joint along the drillstring may be calculated in this manner using the WELLPLAN™ module and the processing unit described in referenced to FIG. 1.

In step 408, values for the coefficients of αⱼ and τⱼ are calculated for each joint along the drillstring. The values of αⱼ and τⱼ may be calculated using equations (12) or equations (13) depending on whether

$$\frac{F}{EI} - {( \frac{{M}_{t}}{EI} )}^{2}$$

is positive or negative. For example, if

$$\frac{F}{EI} - {( \frac{{M}_{t}}{EI} )}^{2}$$

is positive, then equations (12-c), (12-d) and (12-e) may be used to calculate the values of αⱼ and τⱼ as functions of the axial force Fₜ and the twisting moment Mₜ. If

$$\frac{F}{EI} - {( \frac{{M}_{t}}{EI} )}^{2}$$

is negative, however, then equations (13-c), (13-d) and (13-e) must be used to calculate the values of αⱼ and τⱼ. The values of αⱼ and τⱼ at each joint will, most likely, always be different because the axial force Fₜ and the twisting moment Mₜ vary along the drillstring. As demonstrated by equations (12) and equations (13), the values of force (Fₜ) and moment (Mₜ) calculated in step 406 for each joint along the drillstring are used in solving equations (12) and equations (13) for the values of αⱼ and τⱼ for each respective joint. The values of αⱼ and τⱼ for each joint may be calculated in this manner using the Drillstring Trajectory Module and the processing unit described in reference to FIG. 1.

In step 410, a block tri-diagonal matrix is calculated for each connector in the manner described herein for calculating the block tri-diagonal matrix in equation (21). The block tri-diagonal matrix in equation (21) can be seen as a function of χ_{n,k} and χ_{b,k}, which are defined in equations (20). Equations (20) provide the functions U_{n,k} and U_{b,k} that appear as derivatives in the block tri-diagonal matrix in equation (21). The values of αⱼ and τⱼ calculated in step 408 for each joint are used in equations (20) to calculate the block tri-diagonal matrix in equation (21) for each connector. The block tri-diagonal matrix in equation (21) requires continuity in the bending moment for each joint along the entire drillstring, which the conventional torque-drag model does not address. In other words, continuity in the bending moment is addressed by considering the impact on each connector by the rotation of the connector above and below the impacted connector. The block tri-diagonal matrix in equation (21) may be calculated in this manner using the processing unit and the Drillstring Trajectory Module described in reference to FIG. 1.

In step 412, the block tri-diagonal matrix in equation (21) is solved for each connector using predetermined values of αⱼ and τⱼ. The result is a more accurate and desirable drillstring trajectory model, which solves the two unknown rotations χ_{n,k} and χ_{b,k} at each connector that the conventional torque-drag drillstring model does not consider—much less solve. The block tri-diagonal matrix in equation (21) may be solved in this manner using the processing unit and the Drillstring Trajectory Module described in reference to FIG. 1.

In step 414, new values of force (Fₜ) and moment (Mₜ) are calculated for each joint along the drillstring. The solution in step 412 determines all of the unknown coefficients in either equations (16) or equations (18), as appropriate, so that the drillstring trajectory model is completely determined. The forces F_{n,k}⁺ and F_{b,k}⁺ are thus, determined through the use of equations (13) and (14) or the use of equations (16) and (17), as appropriate. The use of these results, together with equations (5) and (22)-(29), determines all forces and moments in the drillstring. The new values of force and moment may more accurately represent the desired drillstring trajectory model than the initial values of force and moment, which were calculated in step 406 using the conventional torque-drag drillstring model. However, since the coefficients (αⱼ, τⱼ) used in formulating the new model depend on the forces and moments, the new values of force and moment should be compared to the initial values of force and moment calculated in step 406 to determine if the new values of force and moment are sufficiently close in value to the initial values of force and moment. The new values of force and moment may be calculated in this manner using the processing unit and the Drillstring Trajectory Module described in reference to FIG. 1.

In step 416, the method 400 determines if the new values of force and moment are sufficiently close to the initial values of force and moment calculated in step 406. The new values of force and moment are compared to the initial values of force and moment on a joint by joint basis to determine whether they are sufficiently close for each joint. If the comparison reveals that the initial values of force and moment and the new values of force and moment are not sufficiently close, then the method 400 returns to step 408 to calculate new values of αⱼ and τⱼ at each joint using the new values of force and moment calculated in step 414. If the comparison reveals that the new values of force and moment and the initial values of force and moment are sufficiently close, then the method 400 ends because the drillstring trajectory model is acceptable. Optionally, the remaining forces and moments determined by equations (22) through equations (24) for sliding and equations (25) through equations (29) for rotating may be calculated once the drillstring trajectory model is determined to be acceptable. In this manner, the drillstring trajectory model, including the corresponding forces and moments, may be repeatedly or reiteratively calculated using the Drillstring Trajectory Module and the processing unit described in reference to FIG. 1 until they are determined to be acceptable. The drillstring trajectory model and the corresponding force and moment calculated according to steps 408-414 may be deemed acceptable when the new values of force and moment are within a range of ±2% of the initial values of force and moment, which may be interpreted as “sufficiently close” in step 416. Other ranges, however, may be acceptable or preferred depending on the application such as, for example, ±1%.

In summary, the new drillstring trajectory model: i) assumes drillstring contact only at the connectors or at a mid point between the connectors, which defines drillstring displacement; ii) reveals that the bending moment at each connector can be made continuous by the proper choice of connector rotation; and iii) uses local Cartesian coordinates for each joint of pipe to simplify equilibrium equations. Thus, the new drillstring trajectory model permits the drillstring trajectory for the drillpipe joints to be engineered in mechanical equilibrium—i.e. satisfies balance of forces and moments.

While the present invention has been described in connection with presently preferred embodiments, it will be understood by those skilled in the art that it is not intended to limit the invention to those embodiments. The present invention, for example, may be applied to model other trajectories, which are common in chemical plants, manufacturing facilities and/or other subsurface applications. It is therefore, contemplated that various alternative embodiments and modifications may be made to the disclosed embodiments without departing from the spirit and scope of the invention defined by the appended claims and equivalents thereof.

1. A method for modeling a drillstring trajectory, comprising:
calculating an initial value of force and an initial value of moment for each joint along a drillstring model using a conventional torque-drag model, a tangent vector, a normal vector and a bi-normal vector for each respective joint;
calculating a block tri-diagonal matrix for each connector on each joint; and
modeling a drillstring trajectory by solving the block tri-diagonal matrix for two unknown rotations at each connector.

2. The method of claim 1, further comprising:
calculating the tangent vector at each survey point using survey data at each respective survey point.

3. The method of claim 2, wherein the survey data comprises an angle (θ), another angle (φ), and a measured depth (s) for each survey point.

4. The method of claim 3, wherein:
\vec{t}ⱼ·\vec{i}_{N}=cos(θⱼ)sin(φⱼ)
\vec{t}ⱼ·\vec{i}_{E}=sin(θⱼ)sin(φⱼ)
\vec{t}ⱼ·\vec{i}_{z}=cos(φⱼ)

5. The method of claim 4, further comprising calculating the normal vector at each survey point using the tangent vector calculated at each respective survey point.

6. The method of claim 5, further comprising calculating the bi-normal vector at each survey point using the tangent vector and the normal vector calculated at each respective survey point.

7. The method of claim 1, further comprising calculating values of αⱼ and τⱼ for each joint along the drillstring.

8. The method of claim 1, further comprising calculating a new value of force and a new value of moment for each joint along the drillstring model.

9. The method of claim 8, further comprising:
comparing the initial value of force and the initial value of moment with the new value of force and the new value of moment to determine if the values are sufficiently close for each joint along the drillstring; and
repeating the steps of calculating a block tri-diagonal matrix for each connector on each joint and modeling the drillstring trajectory by solving the block tri-diagonal matrix for two unknown rotations at each connector if the initial values of force and moment are not sufficiently close to the new values of force and moment.

10. The method of claim 9, wherein the new values of force and moment are sufficiently close to the initial values of force and moment if the new values of force and moment are within a range of ±2% of the initial values of force and moment.

11. A program carrier device for carrying computer executable instructions for modeling a drillstring trajectory, the instructions being executable to implement:
calculating an initial value of force and an initial value of moment for each joint along a drillstring model using a conventional torque-drag model, a tangent vector, a normal vector and a bi-normal vector for each respective joint;
calculating a block tri-diagonal matrix for each connector on each joint; and
modeling a drillstring trajectory by solving the block tri-diagonal matrix for two unknown rotations at each connector.

12. The program carrier device of claim 11, further comprising:
calculating the tangent vector at each survey point using survey data at each respective survey point.

13. The program carrier device of claim 12, wherein the survey data comprises an angle (θ), another angle (φ), and a measured depth (s) for each survey point.

14. The program carrier device of claim 13, wherein:
\vec{t}ⱼ·\vec{i}_{N}=cos(θⱼ)sin(φⱼ)
\vec{t}ⱼ·\vec{i}_{E}=sin(θⱼ)sin(φⱼ)
\vec{t}ⱼ·\vec{i}_{z}=cos(φⱼ)

15. The program carrier device of claim 14, further comprising calculating the normal vector at each survey point using the tangent vector calculated at each respective survey point.

16. The program carrier device of claim 15, further comprising calculating the bi-normal vector at each survey point using the tangent vector and the normal vector calculated at each respective survey point.

17. The program carrier device of claim 11, further comprising calculating values of αⱼ and τⱼ for each joint along the drillstring.

18. The program carrier device of claim 11, further comprising calculating a new value of force and a new value of moment for each joint along the drillstring model.

19. The program carrier device of claim 18, further comprising:
comparing the initial value of force and the initial value of moment with the new value of force and the new value of moment to determine if the values are sufficiently close for each joint along the drillstring; and
repeating the steps of calculating a block tri-diagonal matrix for each connector on each joint and modeling the drillstring trajectory by solving the block tri-diagonal matrix for two unknown rotations at each connector if the initial values of force and moment are not sufficiently close to the new values of force and moment.

20. The program carrier device of claim 19, wherein the new values of force and moment are sufficiently close to the initial values of force and moment if the new values of force and moment are within a range of ±2% of the initial values of force and moment.
